(19) United States
(12) Patent Application Publication
(10) Pub. No.: US 2006/0064822 A1
(43) Pub. Date: Mar. 30, 2006

(54) Automobile escape hammer

(76) Inventor: Tien-Shui Wang, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/950,041

(22) Filed: Sep. 24, 2004

(51) Int. Cl. B25D 1/04

(52) U.S. Cl. 7/144

(57) ABSTRACT

The present invention discloses an automobile escape hammer comprising a body, a striking hammer and a cutter; wherein the striking hammer is coupled to one end of the body and comprises a weight member, a striking pin and a blade installed on the weight member; the striking pin has a small diameter for effectively breaking the windows of a motor vehicle; and the blade abuts one side of the striking pin without passing beyond the end of the striking pin, thereby a user can hold the automobile escape hammer to strike and break the window of a motor vehicle as to achieve the purpose of breaking the window and allowing the people in the vehicle to escape quickly.

### BACKGROUND OF THE INVENTION

1. Field of the Invention

The present invention relates to an automobile escape hammer, more particularly to an automobile escape hammer for breaking the windows of a motor vehicle and allowing the people in the motor vehicle to escape quickly.

2. Description of the Related Art

Please refer to FIG. 4 for the U.S. Pat. No. 6,769,633 entitled “Automobile escape hammer gun”, which disclosed a general automobile escape hammer comprising a body 10, a metal head 61 and a blade 62. The metal head 61 has a tip 611 for striking the windows of a motor vehicle, but the diameter of the metal head 61 is large which makes the thermal manufacturing more difficult and the cost higher. Since the surface area of the metal head 61 is large, therefore it is usually unable to break the windows effectively, which constitutes a major drawback of the automobile escape hammer gun.

In view of the foregoing drawback, the inventor of the present invention designed an automobile escape hammer gun in accordance with another invention as shown in FIG. 1, and such automobile escape hammer gun comprises a body 10, a striking device 11, 12, 13 and a press rod device 14. The striking pin 11 has a small diameter and the tip 111 of the striking pin 11 has a small surface area, and thus it can effectively break the windows of a motor vehicle by a strike to facilitate people in the vehicle to escape.

Although such automobile escape hammer gun can solve the technical issue of the prior-art structure requiring the escape hammer to be aligned and placed flatly onto the window and the press rod device to be pressed to strike the striking pin into the window. The press rod device is released before performing the next strike. Such complicated procedure cannot meet the urgent need for quickly breaking the windows. The body 1 is comprised of two half casings, such that the overall strength of the automobile escape hammer gun is not strong enough and too many components are used, which will make the manufacturing and production costs very high and impractical. Such arrangement demands immediate attention and further improvements.

### SUMMARY OF THE INVENTION

In view of the foregoing shortcomings of the prior art, the automobile escape hammer in accordance with the present invention solves the technical issues of the prior art that requires aligning the escape hammer flatly onto the window for breaking the windows, press the press rod device to strike the windows and release the press rod device before performing the next strike. Such complicated procedure cannot meet the urgent need of quickly breaking the windows. The body 1 is comprised of two half casings, such that the overall strength of the automobile escape hammer gun is not strong enough and too many components are used, which will make the manufacturing and production costs very high and impractical, and thus demands further improvements.

Therefore, it is the primary objective of the present invention to provide an automobile escape hammer comprising a body, a striking hammer and a cutter, wherein the striking hammer is coupled to one end of the body and comprises a weight member, a striking pin and a blade installed on the weight member; the striking pin has a small diameter for effectively breaking the windows of a motor vehicle; and the blade abuts one side of the striking pin without passing beyond the end of the striking pin, thereby a user can hold the automobile escape hammer to strike and break the windows of a motor vehicle as to achieve the purpose of breaking the windows and allowing the people in the vehicle to escape quickly.

### BRIEF DESCRIPTION OF THE DRAWINGS

The above objects, features and advantages of the present invention will become apparent from the following detailed description taken with the accompanying drawing. However, these drawings are provided for reference and illustration and not intended to act as a limitation to the present invention.

FIG. 1 is a perspective view of the automobile escape hammer according to a first embodiment of the present invention.

FIG. 2 is a perspective view of the internal structure of the automobile escape hammer according to a first embodiment of the present invention.

FIG. 3 is an exploded view of the of the automobile escape hammer according to a first embodiment of the present invention.

FIG. 4 is an illustrative view of the mold formation of the automobile escape hammer according to a first embodiment of the present invention.

FIG. 5 is an illustrative view of the automobile escape hammer being used according to a first embodiment of the present invention.

FIG. 6 is an illustrative view of the automobile escape hammer using the striking pin to break the windows of a vehicle according to a first embodiment of the present invention.

FIG. 7 is a perspective view of the automobile escape hammer having a striking pin and a blade on one side of the hammer according to a second preferred embodiment of the present invention.

FIG. 8 is a perspective view of the automobile escape hammer having a blade of a different style according to a third preferred embodiment of the present invention.

FIG. 9 is a view of the automobile escape hammer existing independently according to a fourth preferred embodiment of the present invention.

FIG. 10 is a view of holding the automobile escape hammer to strike the automobile window directly according to the fourth preferred embodiment of the present invention.

### DETAILED DESCRIPTION OF THE PREFERRED EMBODIMENTS

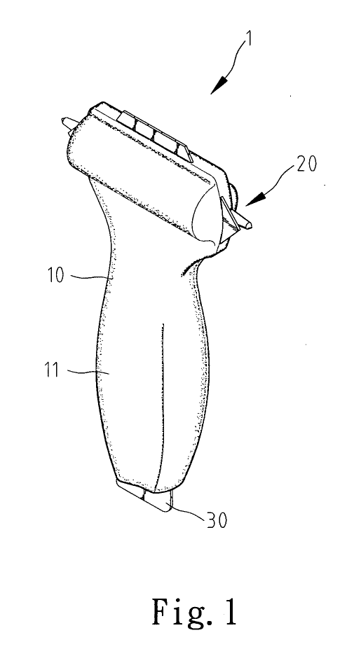

Please refer to FIG. 1 for an automobile escape hammer 1 according to the present invention. The automobile escape hammer 1 comprises: a body 10, a striking hammer 20 and a cutter 30. The body 10 has a handle 11 for allowing a user to grip the automobile escape hammer 1. The striking hammer 20 is coupled to one end of the body 10, and the cutter 30 is coupled to an end of the handle 11 of the body 10. Therefore, in an emergency situation, the striking hammer 20 of the body 10 is used to strike an automobile window and break the glass or release the buckle of a seat belt by using the cutter 30 to cut the seat belt for a quick escape.

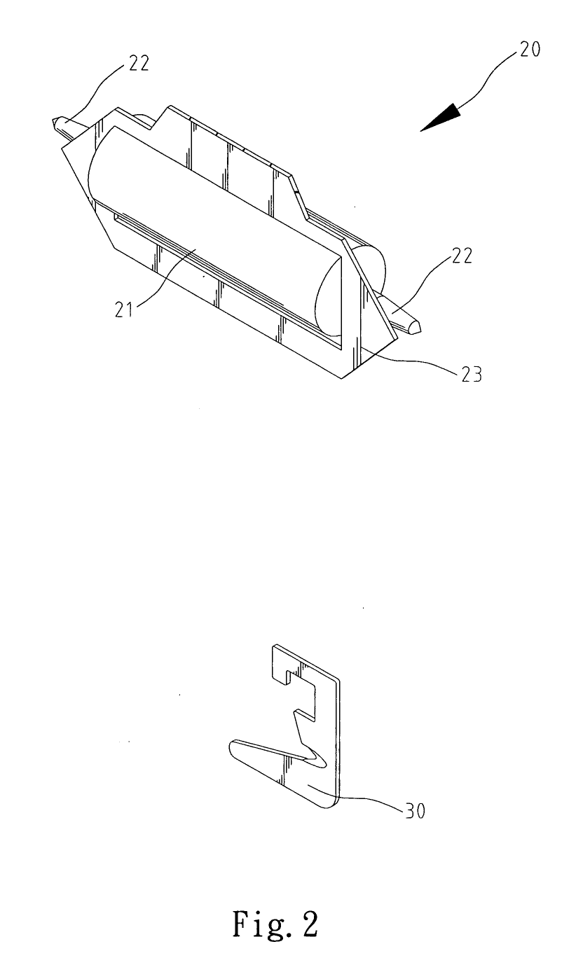

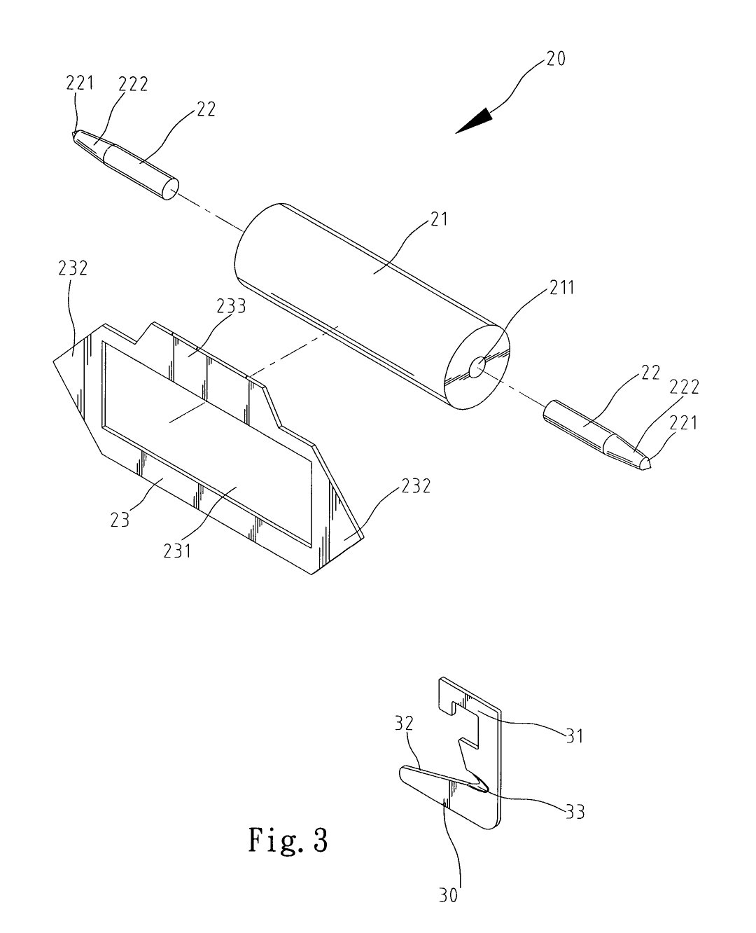

Please refer to FIGS. 2 and 3 for the structures of the striking hammer 20 and the cutter 30 of the present invention. The striking hammer 20 comprises a weight member 21, two striking pins 22 and a blade 23. The weight member 20 is substantially in a cylindrical shape and made of a solid metal material. The weight member 21 comprises an accommodating groove 211 individually disposed on the surface on both ends. The striking pin 22 is disposed into the accommodating groove 211 of the weight member 21, and the striking pin 22 is substantially in a cylindrical shape and made of a solid metal material, and the striking pin 22 is usually hardened by a thermal treatment to provide an excellent strength. The striking pin 22 has a tip 221 and an inclined section 222 at one end. The tip 221 mainly provides the function of breaking automobile windows, and the inclined section 222 maintains the necessary strength required by the tip 221, and provides users the function of pressing and breaking the windows. The blade 23 is designed in a style with a geometric shape and has an opening 231. The blade 23 is coupled to the weight member 21 by means of the opening 231 and disposed on the side proximate to the striking pin 22. A blade section 232 is disposed individually on both ends. A scrape section 233 is protruded from one side. The blade section 232 abuts one side of the striking pin 22 without passing beyond the tip 221 of the striking pin 22. The blade section 232 is mainly used for piecing the plastic film or thermal insulating paper on the glass of an automobile window, and the scrape section 233 is used for scraping away the broken glasses around the automobile window.

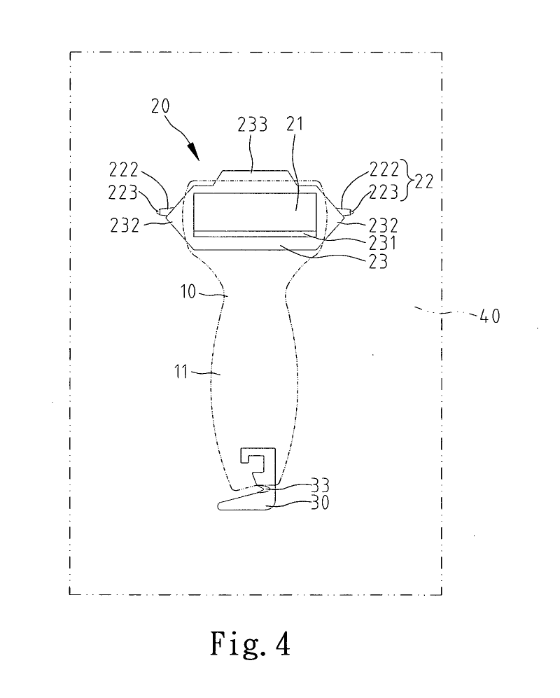

The cutter 30 includes a hook section 31, a block section 32 and a blade section 33 disposed at an end of the block section 32. The hook section 31 is used for coupling and fixing the body 10 as shown in FIG. 4. The block section 32 is provided for sliding a seat belt into the blade section 33 for performing a cutting action.

Please refer to FIG. 4. The striking hammer 20 and the cutter 30 are placed into the mold 40 and coupled to both ends of the body 10, and the body is made of a plastic material, and forms a handle 11. The handle 11 is provided for users to grip. The striking hammer 20 is coupled to one end of the body 10 and only the striking pin 22 and the blade section 232 and the scrape section 233 of the blade 23 are exposed. Only the block section 32 and the blade section 33 are exposed from the cutter 30. Since the hook section 31 is coupled to the end of the handle 11 of the main body, therefore the cutter 30 has good stability.

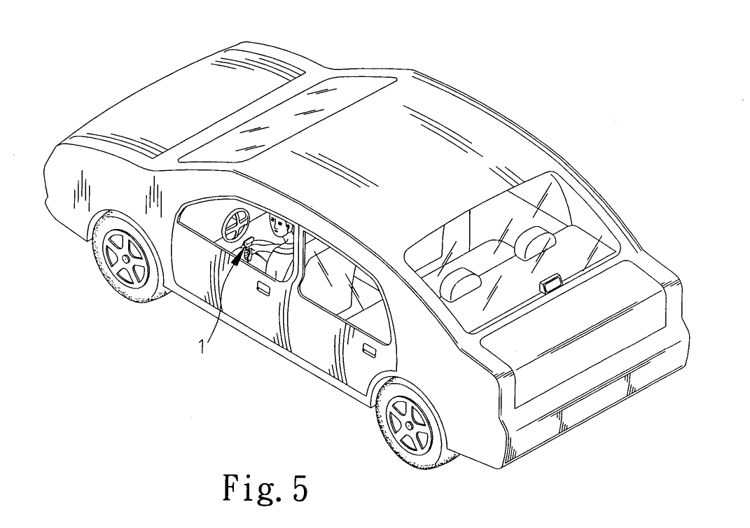

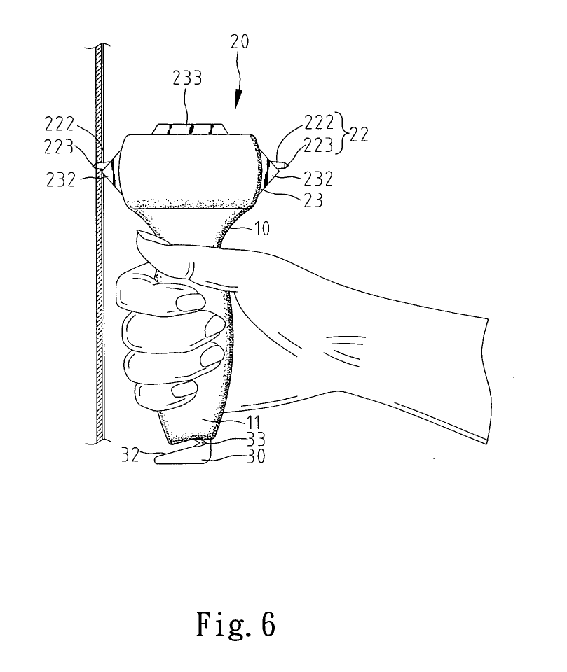

Please refer to FIG. 5 for the automobile escape hammer being used according to the present invention. In the situations of a car accident or an emergency, people are usually trapped in the motor vehicle because the door of the motor vehicle cannot be opened, and then the people in the vehicle can lift the automobile escape hammer 1 to hammer at the automobile window as shown in FIG. 6. After the striking pin pierces into the glass of the automobile window, the window will not be broken immediately because the surface of the glass has a coat of plastic film or a layer of thermal insulating paper. By then, the blade section 232 of the blade 23 cuts the plastic film and the user can shake the body 10 such that the blade section 232 cuts the plastic film to break the glass of the window into pieces. Finally, the scrape section 233 is used to scrape away the broken glasses around the automobile window for a quick escape. In some cases, the seat belt is jammed or damaged and cannot be released. Then, the cutter 30 is provided for cutting the seat belt by extending the extended block section 32 of the seat belt for a quick escape.

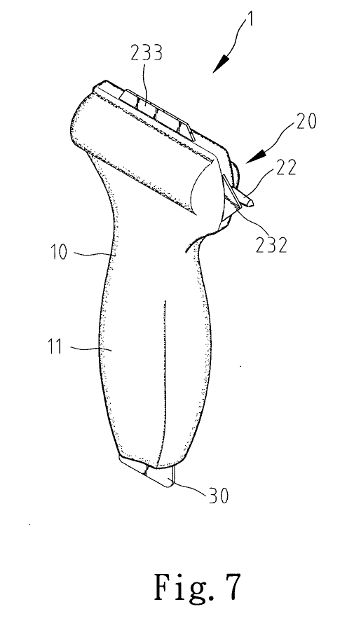

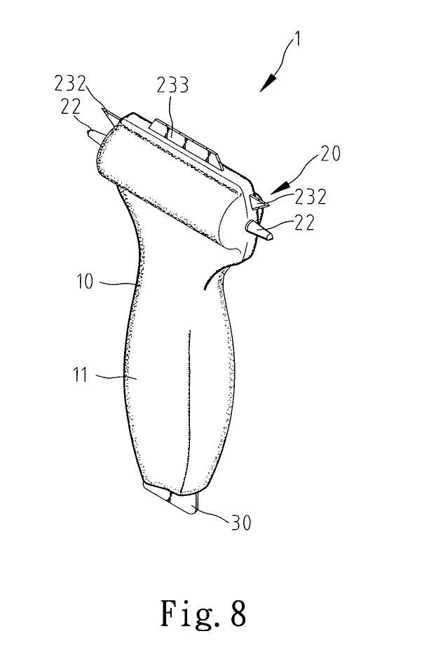

Please refer to FIG. 7 for the automobile escape hammer according to a second preferred embodiment of the present invention. Basically, this embodiment is the same as the foregoing embodiment except the striking hammer 20 has the striking pin 22 and the blade section 232 on one side of the striking hammer 20 only. Please refer to FIG. 8 for the automobile escape hammer according to a third preferred embodiment of the present invention. This embodiment is basically the same as the foregoing embodiment except the blade 23 of the striking hammer 20 comprises a blade section designed in different styles or models.

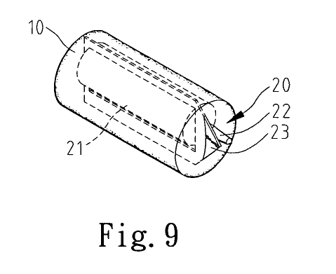

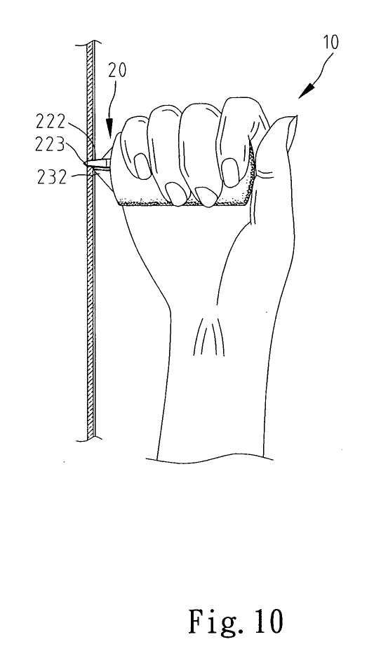

Please refer to FIG. 9 for a fourth preferred embodiment of the present invention. Unlike the aforementioned preferred embodiments, the striking hammer 20 according to this embodiment exists independently and is coupled inside the main body 10. The main body is cylindrical in shape. The striking hammer 20 comprises a weight member 21, and the striking hammer 20 has a striking pin 22 and a blade 23 on one end of the weight member 21. The striking pin 22 is protruded from the body 10, and the blade 23 abuts one side of the striking pin 22 without going beyond the end section of the striking pin 22 for breaking the automobile windows. In FIG. 10, a user may hold the external periphery of the body 10 to break an automobile window for a quick escape during a car accident or an emergency situation. The striking hammer 20 according to this embodiment is convenient to carry, and users can put it in an obvious place in a car without occupying too much space, and the striking hammer 20 is convenient to use as well.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An automobile escape hammer, comprising:
a body, including a first end, a second end and a handle disposed between said first and second ends for providing a grip to users;
a striking hammer, being coupled to said first end of said body and including a weight member, a striking pin disposed on said weight member and a blade installed onto said weight member, and said striking pin having a tip for breaking an automobile window, and one end of said blade abutting a blade section of said striking pin for piercing a plastic mold, and said blade section not passing beyond said tip of said striking pin; and
a cutter, being coupled to said second end of said body for cutting a seat belt; thereby, said automobile escape hammer is provided for breaking said automobile window directly and achieving a quick escape function.

2. The automobile escape hammer of claim 1, wherein said cutter comprises a hammer section being coupled in said body.

3. The automobile escape hammer of claim 1, wherein said cutter further comprises a block section and a blade section disposed at an end of said block section, and said block section is provided for sliding a seat belt into said blade section for performing a cutting action.

4. The automobile escape hammer of claim 1, wherein said weight member comprises an accommodating groove on an end surface of said weight member for installing said striking pin.

5. The automobile escape hammer of claim 1, wherein said striking pin forms an inclined section at position proximate to said tip, and said inclined section provides sufficient strength for said tip to have the function of pressing and breaking said automobile windows.

6. The automobile escape hammer of claim 5, wherein said striking pin is hardened by a thermal treatment and has the function of pressing and breaking said automobile window.

7. The automobile escape hammer of claim 1, wherein said blade comprises an opening for coupling the periphery of said weight member.

8. The automobile escape hammer of claim 7, wherein said blade comprises a scrape section protruded from on side for allowing a user to scrape away broken glasses around the periphery of said automobile window.

9. The automobile escape hammer of claim 1, wherein said weight member comprises a striking pin, each being disposed on both sides of said weight member.

10. The automobile escape hammer of claim 9, wherein said blade has a blade section on both sides

11. The automobile escape hammer of claims 1 or 10, wherein said blade is a blade designed in a model with different various styles.

12. The automobile escape hammer of claim 1, wherein said body is formed by mold formation and coupled to said striking hammer and said cutter.

13. An automobile escape hammer, comprising:
a body, being in a cylindrical shape;
a striking hammer, being coupled inside said body and including a weight member, and
a striking pin disposed on said weight member and a blade installed onto said weight member, and said striking pin having a tip protruded from said body for breaking an automobile window, and one end of said blade abutting a blade section of said striking pin for piercing a plastic mold, and said blade section not passing beyond said tip of said striking pin;
thereby, said automobile escape hammer is provided for breaking said automobile window directly and achieving a quick escape function.

14. The automobile escape hammer of claim 13, wherein said weight member comprises an accommodating groove on one end surface for installing said striking pin.

15. The automobile escape hammer of claim 13, wherein said striking pin forms an inclined section at a position proximate to said tip and said inclined section provides a good strength to said tip and is capable of pressing and breaking said automobile window.

16. The automobile escape hammer of claim 15, wherein said striking pin is hardened by a thermal treatment and has a good strength.

17. The automobile escape hammer of claim 13, wherein said blade comprises an opening for coupling with the periphery of said weight member.
